(19) United States
(12) Patent Application Publication
(10) Pub. No.: US 2004/0109445 A1
(43) Pub. Date: Jun. 10, 2004

(54) Systems and methods for selectively diverting data from nodes

(76) Inventors: Julie Fouquet, Portola Valley, CA (US); Datong Chen, Fremont, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/314,687

(22) Filed: Dec. 9, 2002

(51) Int. Cl. H04L 12/28; H04L 12/56

(52) U.S. Cl. 370/389

(57) ABSTRACT

Methods for propagating data are provided. A representative method includes: receiving an optical signal at a first location associated with a first node; determining, at the first location, whether data of the optical signal is to be provided to a destination corresponding to the first node; and diverting the optical signal away from the first node and to a second node if the data of the optical signal is not to be provided to a destination corresponding to the first node. Systems and other methods also are provided.

### FIELD OF THE INVENTION

The present invention generally relates to communications. More specifically, the invention relates to systems and methods that involve selectively diverting data away from particular nodes of communication networks.

### DESCRIPTION OF THE RELATED ART

Much effort is associated with increasing the data-handling capacity of communication networks. Accordingly, there has been a trend toward optical communication networks, which tend to provide greater data capacity or “bandwidth” than electrically-based communication networks. A representative example of a portion of a prior art communication network is depicted in FIG. 1.

In FIG. 1, communication network 100 includes multiple nodes that are interconnected by transmission media. More specifically, node 102 communicates data to node 104 via a transmission medium or segment 106. Segment 106 can be an electrical cable or an optical fiber, for example. Note that when optical fiber is used, the optical signal propagated by the optical fiber typically is converted to an electrical signal prior to or at the node. Additionally, segment 108 provides data to node 102 and segment 110 provides data from node 104 to a downstream (“next”) node (not shown).

In FIG. 1, nodes 102 and 104 each include at least one electrical packet switch. Each electrical packet switch receives data packets in the form of electrical signals. Each electrical packet switch directs the data packets toward their respective intended destinations. In particular, each packet switch determines whether a data packet is to be directed to a destination that the packet switch services or a destination serviced by another packet switch (node).

By way of example, the packet switch of node 102 can receive a data packet via segment 108. After receipt, the data packet is analyzed, such as after being stored in cache memory of the packet switch. If the packet switch determines that the data packet is to be directed to a next node, e.g., node 104, the data packet is placed (buffered) in a queue. The data packet then is directed to the next node when a transmission medium is available for propagating the data packet. If, however, the packet switch determines that the data packet is designated for delivery to a destination corresponding to the packet switch, the packet switch directs the data packet to that destination. For instance, the data packet may be directed to an address corresponding to a device 112, e.g., a work station.

As the number of data packets arriving at an electrical packet switch increases, the latency or time delay associated with data propagation of the packet switch also typically increases. This is due, at least in part, to the aforementioned processes of caching and/or buffering the data packets within the packet switch.

Based on the foregoing, it should be appreciated that there is a need for improved systems and methods that address these and/or other perceived shortcomings of the prior art. For instance, it is desirable to provide communication systems that exhibit reduced latency compared to communication systems of the prior art.

### SUMMARY OF THE INVENTION

Briefly described, the present invention involves routing of data signals in communications systems. In particular, since a node of a communication system may not be associated with an intended destination of a data signal, the system can bypass or divert the data signal away from the node. Thus, much of the latency typically associated with the propagation of data signals among the nodes of a communication system can be reduced. More specifically, the latency associated with bypassed nodes of a communication system can be avoided.

A communication system in accordance with the invention incorporates an optical bypass system. The optical bypass system receives an optical signal and determines whether data of the optical signal is to be provided to a destination corresponding to a first node. The optical bypass system also diverts the optical signal away from the first node if the data of the optical signal is not to be provided to a destination corresponding to the first node.

A method in accordance with the invention for propagating data between nodes using optical signals includes: receiving an optical signal at a first location associated with a first node; determining, at the first location, whether data of the optical signal is to be provided to a destination corresponding to the first node; and diverting the optical signal away from the first node and to a second node if the data of the optical signal is not to be provided to a destination corresponding to the first node.

Clearly, embodiments of the invention may exhibit features and/or advantages in addition to, or in lieu of, those mentioned above. Additionally, other systems, methods, features, and/or advantages of the present invention will be or become apparent to one with ordinary skill in the art upon examination of the following drawings and detailed description. It is intended that all such additional systems and/or methods be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram depicting a portion of a representative prior art communication network.

FIG. 2 is a schematic diagram depicting a portion of an embodiment of a communication system in accordance with the present invention.

FIG. 3 is a flowchart depicting functionality of the embodiment of the optical bypass system of FIG. 2.

FIG. 4 is a schematic diagram depicting the embodiment of FIG. 2, showing detail of the optical bypass system.

FIG. 5 is a schematic diagram depicting another embodiment of an optical bypass system that can be used in the communication system of FIG. 2.

FIG. 6 is a flowchart depicting functionality of the embodiment of the control system of FIG. 5.

FIG. 7 is a schematic diagram depicting a portion of another embodiment of a communication system in accordance with the present invention.

FIG. 8 is a schematic diagram depicting a computer or processor-based system that can be used to implement controllers in accordance with the present invention.

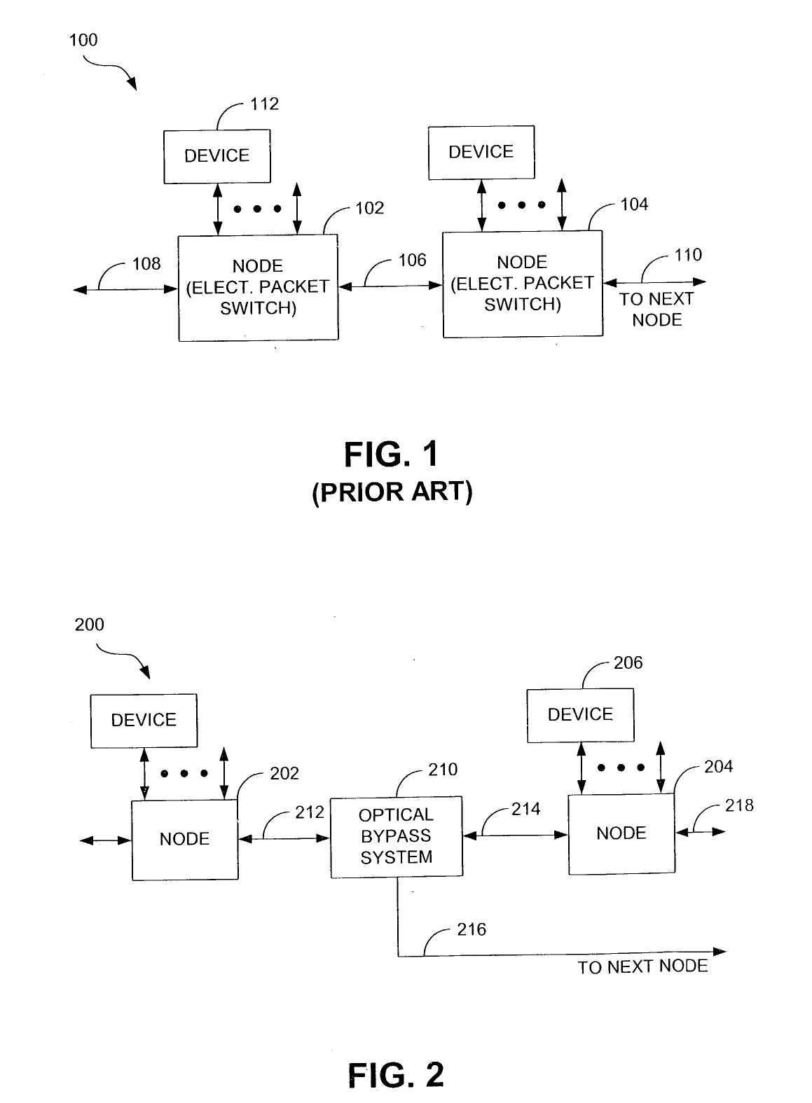

### DETAILED DESCRIPTION

Referring again to the drawings, FIG. 2 depicts a portion of a representative embodiment of a communication system 200 in accordance with the present invention. As will be described in greater detail later, communication system 200 directs data, e.g., data packets, away from one or more nodes that do not correspond to the intended destination of the data. For instance, if a node of the communication system is not required for directing a data packet to the destination to which the data packet is addressed, the communication system can direct the data packet so that the node is bypassed. In this manner, the number of data packets provided to and directed by that node can be reduced. Thus, latency of that node can be avoided.

As shown in FIG. 2, communication system 200 includes nodes 202 and 204. Nodes 202 and 204 can incorporate electrical packet switches or routers, for example, for directing incoming data among multiple outputs. An optical bypass system 210 communicates with node 202. More specifically, the optical bypass system receives data packets from node 202 via a segment 212. When directing data packets to node 204, optical bypass system 210 directs the data packets via segment 214. When directing data packets to a next node, (not shown) i.e., a node downstream from node 204, optical bypass system 210 directs the data packets via segment 216. Node 204 also is able to direct data packets to the next node, such as via segment 218. Note, segments 212, 214, 216 and 218 communicate optical signals. In other embodiments, however, one or more of the segments can propagate electrical signals.

In the embodiment of FIG. 2, optical bypass system 210 selectively directs data packets away from node 204 of the communication system. More specifically, optical bypass system 210 can selectively direct the data packets to the next node. In this embodiment, the communication system provides data packets to the optical bypass system in the form of an optical signal. The optical bypass system then analyzes the optical signal and determines whether the optical signal is to be provided to node 204, i.e., whether node 204 is required for routing the optical signal to its intended destination. If it is determined that the optical signal is not to be provided to the node 204, the optical bypass system diverts the optical signal from node 204, and directs the optical signal to a next node.

Optical bypass systems in accordance with the present invention can reduce the amount of time required for a data packet to be propagated through various nodes of a communication system. In particular, if a data packet is analyzed by an optical bypass system of a node and the data packet does not require directing from that node, that node can be bypassed. Thus, the data packet is not delayed at that node by the time interval(s) associated with one or more of caching the data packet, reading the header of the data packet, determining routing for the data packet, and buffering the data packet until an output transmission medium of the node is available for propagating the data packet. Additionally, losses associated with converting the data packets for use with an electrical packet switch of a node, i.e., converting an optical signal to an electrical signal and then back to an optical signal, can be avoided.

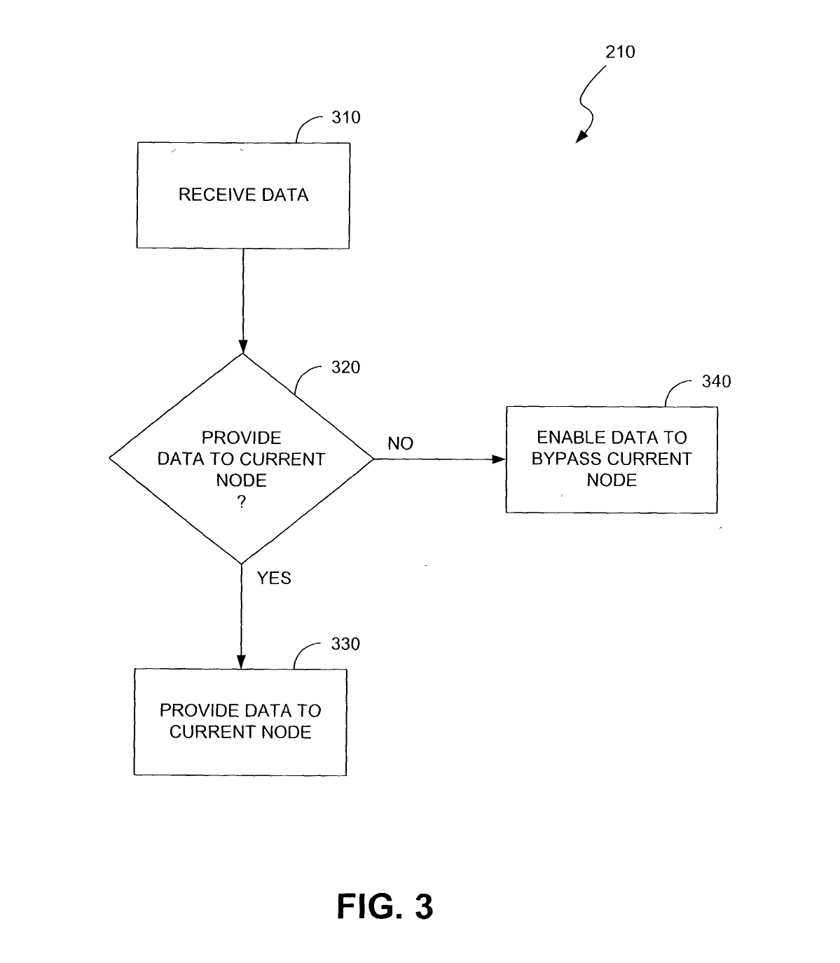

Functionality of the embodiment of the optical bypass system 210 of FIG. 2 is presented in the flowchart of FIG. 3. It should be noted that, in some alternative implementations, the functions noted in the various blocks of this and/or other flowcharts depicted in the accompanying disclosure may occur out of the order depicted. For example, two blocks shown in succession in FIG. 3 may be performed concurrently.

As shown in FIG. 3, the optical bypass system or method 210 may be construed as beginning at block 310 where data is received. By way of example, the data can be provided in the form of a data packet that includes a header. In block 320, a determination is made as to whether the data received is to be directed to a current node, i.e., a node associated with the component(s) involved in the determination of block 320. When the data is a data packet, this can be accomplished by analyzing the header. If it is determined in block 320 that the data is to be directed to the current node, the data is directed to the current node. If, however, it is determined that the data is not to be directed to the current node, the optical bypass system enables the data to bypass the current node (block 340). Thus, the data can be provided to another node.

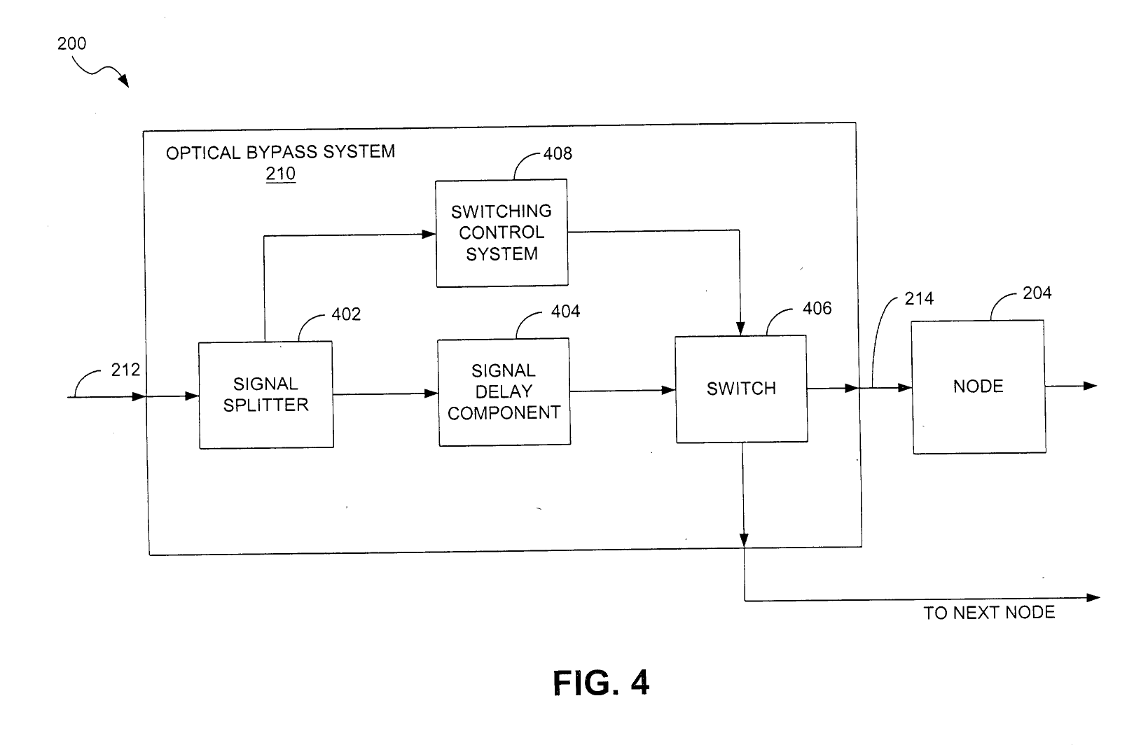

Another embodiment of an optical bypass system 210 is depicted schematically in FIG. 4. As shown in FIG. 4, the optical bypass system includes a signal splitter 402, a signal delay component 404, a switch 406, and a switching control system 408. Signal splitter 402 receives a data signal via segment 212. Signal splitter 402 divides the data signal into at least first and second signal components. Signal splitter 402 then provides the first signal component, which can be a relatively small portion, e.g., 1%, of the original data signal to switching control system 408. The second signal component of the data signal is provided to signal delay component 404.

Signal delay component 404 delays the second signal component of the data signal for a period of time that permits the switching control system to determine whether the data signal, e.g., a data packet, is to be directed to node 204. In this regard, signal splitter 402 only needs to provide that portion of the data signal to the control system that enables the control system to perform the aforementioned determination. Based upon that determination, switching control system 408 provides a control signal to switch 406. More specifically, if the data packet is to be directed to node 204, the switching control system enables the switch to direct the data signal, i.e., the second signal component that was delayed by signal delay component 404, to node 204. If, however, the data packet is not to be directed to node 204, the switching control system enables the switch to direct the data signal to a next node.

Note, each of the data signal, first signal component and second signal component can be provided as optical or electrical signals. For instance, in some embodiments, the data signal can be an optical signal that is split by the signal splitter. The first signal component could then be converted to an electrical signal prior to analysis or alternatively, analyzed as an optical signal. Similarly, the second signal component could be optically delayed or, alternatively, converted to an electrical signal and then delayed. Preferably, the second signal component remains in the optical domain within the optical bypass system.

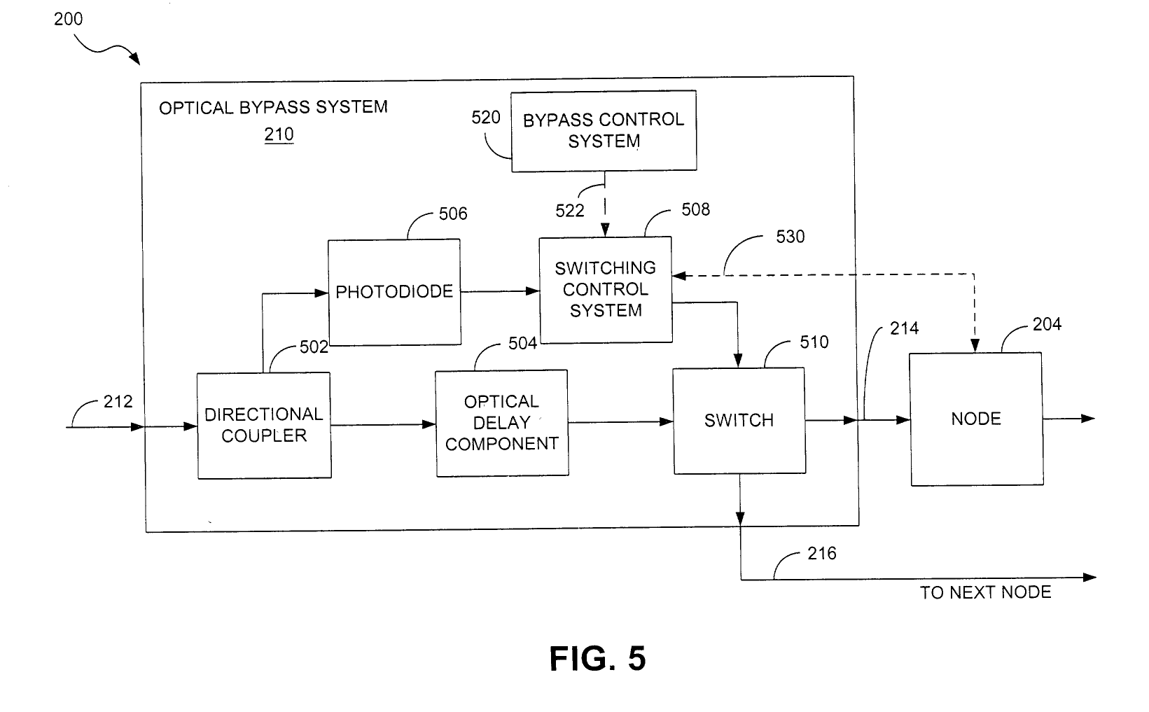

A portion of another embodiment of a communication system 200 in accordance with the invention is depicted schematically in FIG. 5. In the embodiment of FIG. 5, optical bypass system 210 includes a directional coupler 502, an optical delay component 504, a photodiode 506, a switching control system 508 and a switch 510.

In operation, a data signal that includes data packets is provided to directional coupler 502 of the optical bypass system in the form of an optical signal. The directional coupler splits the received optical signal into first and second optical signal components. The first optical signal component is provided to optical delay component 504. For example, ninety-eight percent of the received optical signal could he provided to the optical delay component. The second optical signal component of the optical signal, e.g., two percent of the optical signal, is provided from the directional coupler to a photodiode 506. Photodiode 506 converts the optical signal into an electrical signal and provides the electrical signal to switching control system 508.

Note that the electrical signal provided to the switching control system should be adapted to permit analysis of the electrical signal (described hereinafter). Therefore, the second optical signal component that is provided to the photodiode should be selected and/or the electrical signal should be conditioned, e.g., equalized, to facilitate this functionality.

Switching control system 508 analyzes the electrical signal. In particular, switching control system 508 determines whether the header of the data packet is associated with the current node, e.g., node 204. The switching control system then provides a control signal, e.g., a predetermined analog voltage, to switch 510. The control signal enables the switch to selectively direct the optical signal, i.e., the first optical signal component that is being delayed by the optical delay component, either to node 204 or to a next node. Note, the switch can be an electro-optical switch, such as an LiNbO₃ or compound semiconductor-based switch, for example.

The embodiment of the optical bypass system 210 of FIG. 5 maintains the data packet that is to be directed to either node 204 or the next node in the form of an optical signal. However, analysis of the data packet is accomplished by analyzing a portion of the optical signal that has been converted to an electrical signal. This methodology potentially provides an optical bypass system that benefits from the long range of optical signal transmission, while using electronic components, which typically are less costly and more robust than optical components, to perform the data analysis function.

The embodiment of the communication system 200 of FIG. 5 also includes a bypass control system 520. Bypass control system 520 communicates with switching control system 508. The bypass control system provides a bypass control signal to the switching control system. For instance, if maintenance procedures are to be performed on the packet switch of a node during a particular time interval, the bypass control signal is sent to the switching control system so that data packets are diverted away from the node during maintenance.

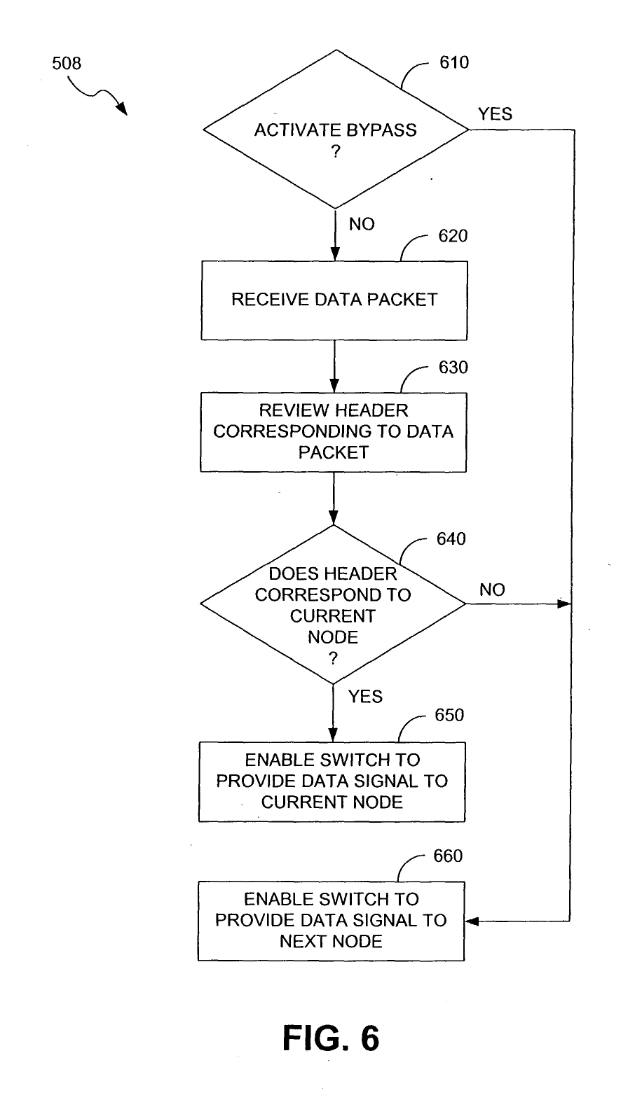

Functionality of the embodiment of the optical bypass system of FIG. 5 and, more specifically, functionality of the switching control system 508, is presented in the flowchart of FIG. 6. As shown in FIG. 6, the optical bypass system or method may be construed as beginning at block 610, where a determination is made as to whether bypass functionality of the optical bypass system is to be actuated. Such a determination can be based on receipt of a control signal, such as a control signal provided from a bypass control system 520 of FIG. 5. If it is determined that bypass functionality is not to be actuated, the method proceeds to block 620 where a data packet is received. In block 630, the header of the data packet is analyzed. Thereafter, such as depicted in block 640, a determination is made as to whether the header of the data packet corresponds to the current node. If it is determined in block 640 that the header corresponds to the current node, the optical bypass system directs the data packet to the current node (block 650). If, however, it is determined that the header does not correspond to the current node, the optical bypass system directs the data packet to a next node (block 660). If it was determined in block 610 that the bypass is to be activated, the process also proceeds to block 660 so that the data packet is directed to the next node.

Additionally, or alternatively, the bypass control system 520 can be used to provide switching control system 508 with a control signal for disabling bypass functionality. For example, such a signal can route all data to a node, such as node 204, associated with the optical bypass system 210.

In some embodiments, the control system receives inputs from other systems and/or components of the communication system. For example, assume that node 204 provides information (depicted by dashed arrow 530) to the switching control system that indicates that packet switch of node 204 is malfunctioning. In response to this information, the switching control system diverts data packets away from the malfunctioning packet switch.

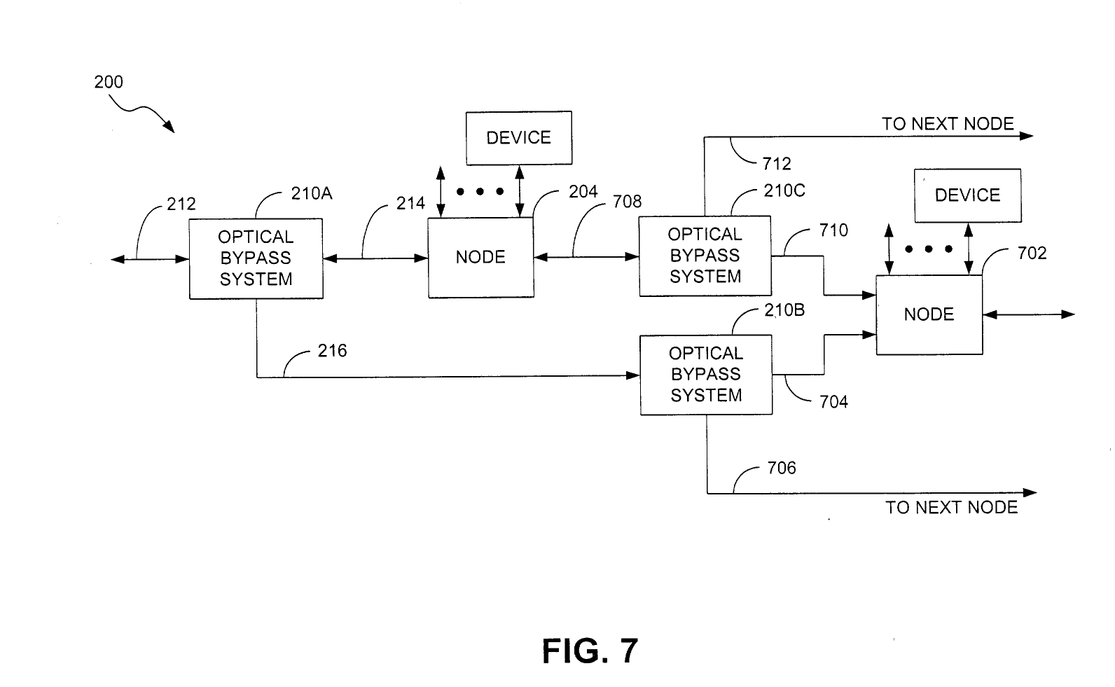

A representative portion of another embodiment of communication system 200 in accordance with the invention is depicted in FIG. 7. As shown in FIG. 7, the communication network includes multiple optical bypass systems, e.g., optical bypass systems 210A, 210B and 210C. Optical bypass system 210A receives data packets via segment 212. Each data packet received by optical bypass system 210A then is directed either to the current node, e.g., node 204, via segment 214 or to optical bypass system 2101B via segment 216. Optical bypass system 2101B selectively directs data packets either to node 702 via segment 704 or to a next node (not shown) via segment 706. Node 702 also can receive data packets from optical bypass system 210C. Optical bypass system 210C receives data packets from node 204 via segment 708. Optical bypass system 210C selectively directs the data packets either to node 702 via segment 710 or to a next node (not shown) via segment 712. Thus, as shown in the representative embodiment of FIG. 7, multiple optical bypass systems can be used in association with adjacent nodes of a communication system.

Control systems of the present invention, e.g., switching control systems 408 (FIG. 4) and 508 (FIG. 5), and bypass control system 520 (FIG. 5), can be implemented in software, firmware, hardware, or a combination thereof. Clearly, due primarily to processing speed considerations, hardware implementations for the switching control systems are preferred. When implemented in hardware, each of the control systems can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

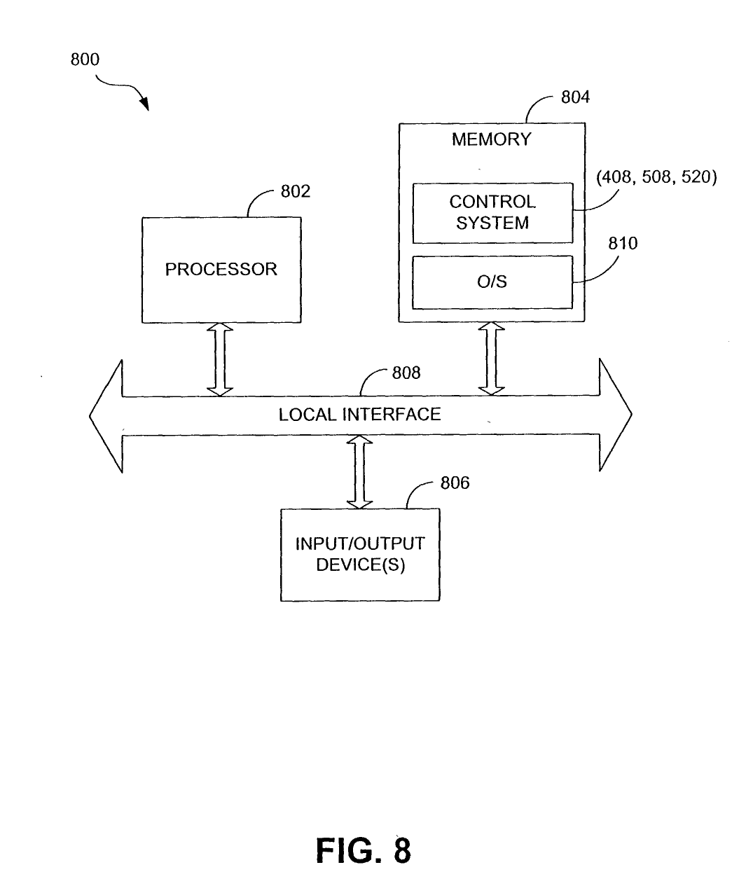

In alternative embodiments, the aforementioned control systems could be implemented in software as executable programs. For example, each control system can be executed by a special or general purpose digital computer. An example of a general purpose computer that can implement such a control system is shown schematically in FIG. 8.

Generally, in terms of hardware architecture, computer 800 includes a processor 802, memory 804, and one or more input and/or output (I/O) devices 806 (or peripherals) that are communicatively coupled via a local interface 808. The software in memory 804 can include one or more separate programs, each of which comprises an ordered listing of executable instructions for implementing logical functions. In the example of FIG. 8, the software in the memory 804 includes a control system (408, 508, 520) and an operating system (O/S) 810.

When control system (408, 508, 520) is implemented in software, it should be noted that the control system can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. Control system (408, 508, 520) can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to illustrate the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A method for propagating data between nodes using optical signals, said method comprising:
receiving an optical signal at a first location associated with a first node;
determining, at the first location, whether data of the optical signal is to be provided to a destination corresponding to the first node; and
diverting the optical signal away from the first node and to a second node if the data of the optical signal is not to be provided to a destination corresponding to the first node.

2. The method of claim 1, wherein the data associated with the optical signal is provided as data packets; and
wherein determining comprises:
analyzing a header associated with at least one of the data packets to determine whether the header corresponds to a destination associated with the first node.

3. The method of claim 1, further comprising:
splitting the optical signal into a first optical signal component and a second optical signal component; and
delaying the first optical signal component; and
wherein analyzing comprises analyzing the header of at least one of the data packets of the second optical signal component during a time associated with delay of the first optical signal component.

4. The method of claim 3, wherein analyzing the header of at least one of the data packets of the second optical signal component comprises:
converting the second optical signal component into an electrical signal; and
analyzing the electrical signal.

5. The method of claim 1, further comprising:
providing an optical switch; and
wherein diverting comprises diverting the optical signal with the optical switch.

6. The method of claim 1, wherein each of the first node and the second node includes a packet switch for routing the data of the optical signal.

7. The method of claim 6, wherein each~packet switch is an electrical packet switch.

8. A communication system for propagating data between nodes using optical signals, said communication system comprising:
an optical bypass system operative to receive an optical signal, determine whether data of the optical signal is to be provided to a destination corresponding to a first node, and divert the optical signal away from the first node if the data of the optical signal is not to be provided to a destination corresponding to the first node.

9. The communication system of claim 8, wherein the optical bypass system comprises:
an optical switch operative to provide data of the optical signal selectively to one of the first node and at least another node.

10. The communication system of claim 9, wherein the optical bypass system further comprises:
a signal splitter communicating with the optical switch, the signal splitter being operative to receive a signal corresponding to the optical signal and split the optical signal into a first signal component and a second signal component; and
a signal delay component communicating with the signal splitter and the optical switch, the signal delay component being operative to receive the first signal component and impart a propagation delay to the first signal component prior to enabling the first signal component to be provided to the optical switch.

11. The communication system of claim 10, wherein:
the signal splitter is a directional coupler optically communicating with the optical switch; and
the signal delay component is an optical delay component optically communicating with the signal splitter and the optical switch.

12. The communication system of claim 10, wherein the optical bypass system further comprises:
logic configured to determine whether data of the optical signal is to be provided to a destination corresponding to a first node;
logic configured to enable the first signal component to be provided to the first node; and
logic configured to enable the first signal component to be diverted away from the first node such that:
if the data of the optical signal is to be provided to a destination corresponding to the first node, the switching control system enables the first signal component to be provided to the first node; and
if the data of the optical signal is not to be provided to a destination corresponding to the first node, the switching control system enables the first signal component to be diverted away from the first node.

13. The communication system of claim 10, wherein the optical bypass system further comprises:
a switching control system communicating with the signal splitter and the optical switch, the switching control system being operative to receive the second signal component and determine whether data of the optical signal is to be provided to a destination corresponding to a first node such that:
if the data of the optical signal is to be provided to a destination corresponding to the first node, the switching control system enables the first signal component to be provided to the first node; and
if the data of the optical signal is not to be provided to a destination corresponding to the first node, the switching control system enables the first signal component to be diverted away from the first node.

14. The communication system of claim 13, wherein the optical bypass system further comprises:
a photodiode arranged to receive the second signal component, as an optical signal, from the signal splitter, convert the second signal component into an electrical signal, and provide the second signal component, as the electrical signal, to the switching control system.

15. The communication system of claim 13, wherein the operative bypass system further comprises:
means for converting the second signal component into an electrical signal.

16. The communication system of claim 8, further comprising:
an input transmission medium communicating with the optical bypass system, the input transmission medium being operative to provide signals to the optical bypass system; and
an output transmission medium communicating with the optical bypass system, the output transmission media being operative to receive signals from the optical bypass system.

17. The communication system of claim 8, further comprising:
a bypass control system communicating with the optical bypass system, the bypass control system being operative to provide a control signal to the operative bypass system such that the operative bypass system diverts optical signals away from the first node.

18. The communication system of claim 8, further comprising:
a bypass control system communicating with the optical bypass system, the bypass control system being operative to provide a control signal to the operative bypass system such that the operative bypass system directs optical signals to the first node.

19. The communication system of claim 8, wherein the optical bypass system is a first optical bypass system; and further comprising:
a second optical bypass system communicating with the first optical bypass system and being operative to receive optical signals diverted away from the first node.

20. The communication system of claim 19, further comprising:
a third optical bypass system communicating with the first node and operative to receive optical signals from the first node.
